(19) United States
(12) Patent Application Publication
(10) Pub. No.: US 2002/0197589 A1
(43) Pub. Date: Dec. 26, 2002

(54) Interactive educational apparatus with number array

(75) Inventors: Michael C. Wood, Orinda, CA (US); Jorge Gabriel Soto, Concord, CA (US); Patricia Root Collier, Danville, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LeapFrog Enterprises, Inc., Emeryville, CA

(21) Appl. No.: 10/177,795

(22) Filed: Jun. 19, 2002

Related U.S. Application Data
(60) Provisional application No. 60/301,344, filed on Jun. 26, 2001.

(51) Int. Cl. G09B 5/00

(52) U.S. Cl. 434/201; 434/169; 434/309

(57) ABSTRACT

An interactive apparatus is disclosed. In one embodiment, the interactive apparatus includes an array of switches, an array of numbers respectively associated with the array of switches, a speaker, a processor coupling the array of switches and the speaker, a memory and a set of movable physical objects. The physical objects are spatially separated from the array of numbers and movable objects within the set are capable of being grouped together to form a group of objects that represents at least some of the numbers in array of numbers.

### CROSS-REFERENCE TO RELATED APPLICATIONS

This application claims the benefit of the filing date of U.S. Provisional Patent Application No. 60/301,344, filed Jun. 26, 2001, which is herein incorporated by reference in its entirety for all purposes.

### BACKGROUND OF THE INVENTION

Devices for teaching mathematics are known. One such device is called the Math Shark™. According to product descriptions, it has an LCD (liquid crystal display) screen that displays problems and gives feedback to the user after the user has attempted the problems. Also, according to the product descriptions, it sharpens mental math skills from basics to pre-algebra with eight levels of skill.

While devices such as the Math Shark™ are effective in some instances, a number of improvements could be made. For instance, such devices are generally not intended for younger children, who are learning how to count and are learning basic math. Also, the Math Shark™ has few features that can engage and invite young children to use it.

Moreover, even if one could adapt such electronic devices to teach very young children, such electronic devices only provide questions and answers without showing how such questions and answers relate to real world objects. It is therefore difficult for a child to visualize how numbers and math might relate to real life. Furthermore, such electronic devices are typically not adapted to teach a child how to write numbers. In order for a young child to truly learn about numbers, the child needs to know how to write numbers. When a user writes numbers, numerical and mathematical concepts are reinforced in the user.

Embodiments of the invention address these and other problems.

### SUMMARY OF THE INVENTION

Embodiments of the invention are directed to interactive educational apparatuses that are adapted to educate a user about numbers and math.

One embodiment of the invention is directed to an interactive educational apparatus comprising: a) an array of switches; b) an array of numbers respectively associated with the array of switches; c) a processor operatively coupled to the array of switches; d) an output device operatively coupled to the processor; e) a memory operatively coupled to the processor; f) a housing, wherein the processor is housed in the housing; and g) a set of movable physical objects coupled to the housing, wherein the physical objects within the set are capable of being grouped together to form a group of objects that represents at least some of the numbers in array of numbers.

Another embodiment of the invention is directed to an interactive educational apparatus comprising: a) an array of switches; b) an array of numbers respectively associated with the array of switches; c) a processor operatively coupled to the array of switches; d) an output device operatively coupled to the processor; e) a memory operatively coupled to the processor; f) a housing, wherein the processor is housed in the housing; and g) a writing medium spaced from the array of numbers.

These and other embodiments of the invention are described in further detail below with reference to the following figures and detailed description.

### BRIEF DESCRIPTION OF THE DRAWINGS

FIG. 1 shows a plan view of an interactive educational apparatus according to an embodiment of the invention.

FIG. 2 shows a block diagram of some components in an interactive educational apparatus according to an embodiment of the invention.

FIG. 3 shows a flowchart of a process according to an embodiment of the invention when the interactive educational apparatus is in a counting mode.

FIG. 4 shows display screens that show how the interactive educational apparatus can teach a user how to add numbers together.

FIGS. 5(a) and 5(b) show a specific circuit diagram that can be used in an embodiment of the invention.

### DETAILED DESCRIPTION

Embodiments of the invention are directed to interactive educational apparatuses. The interactive educational apparatus embodiments can be designed to educate a user about numbers. Typically, the user is a young child (e.g., a toddler, a pre-school age child, or an elementary school age child) and the numbers that are taught and manipulated are less than 100. The interactive educational apparatus can teach a user, for example, number recognition, addition, subtraction, multiplication, division, number ranges, numerical values, number writing, fractions, and decimals. In some embodiments, the interactive educational apparatus may be considered an educational toy.

Embodiments of the invention offer a number of advantages over conventional number or math educational apparatuses. For example, in embodiments of the invention, the user can practice writing numbers and learn how numbers and mathematical operations relate to real-world objects. The user can also electronically interact with the apparatus by pressing buttons that are associated with numbers. Questions can be presented by a synthesized voice coming from the apparatus. The user can answer the questions by pressing appropriate buttons, and audio and visual feedback can be provided to the user in response to the user's input. In some embodiments of the invention, a single apparatus can include all of these features and also music and games so that the apparatus embodiments are fun, inviting, and engaging.

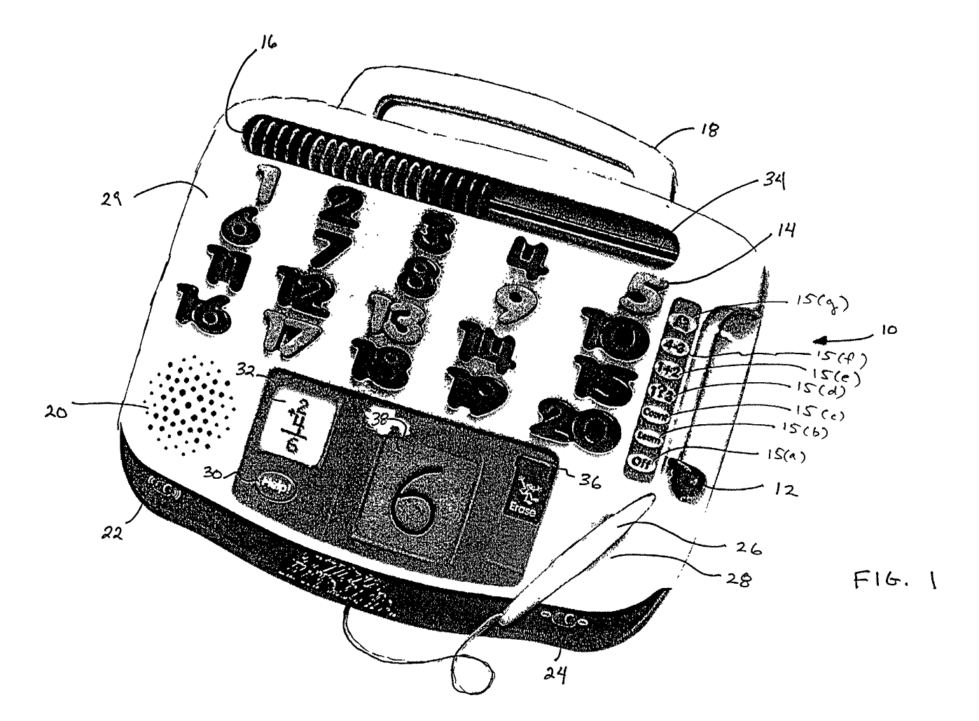

FIG. 1 shows the exterior of an interactive educational apparatus 10 according to an embodiment of the invention. The front of the apparatus 10 includes an array of numbers 14, a writing medium 38, and a set of movable objects 16 spaced from each other. The apparatus 10 may also include a housing 29 and a handle 18 that allows a user to carry it. A speaker 20 may be provided so that audio output can be presented to the user. A display screen 32 can provide visual output for the user. While the apparatus 10 may be of any suitable size, an exemplary apparatus may be 12″ wide×10.75″ high×2.24″ deep. It can be portable and light enough to be carried by a toddler. Accordingly, embodiments of the invention can be used at home, at school, in the car, on the bus, etc.

The array of numbers 14 includes the numbers 1 through 20 in the form of depressible buttons. Each button can be molded plastic in the form of one of the numbers 1 to 20. Alternatively, each button can have the same shape, but can have a number printed on it. Each button can independently activate a pressure sensitive switch underneath it to send a signal to a processor in the apparatus 10 that the user has pressed the button. It is understood that the array of numbers 14 is not limited to the particular numbers shown in FIG. 1. For example, the range of numbers in the array could be extended to 25 or more, or even 10 or less, in some embodiments. Moreover, the numbers may be numbers from another language such as Chinese numbers.

Any suitable writing medium 38 can be used in embodiments of the invention. The writing medium 38 may be, for example, an erasable medium such as an magnetophoretic screen or a Magic-Slate™ type writing screen. Each of these types of erasable media is indirectly erasable. Such media are indirectly erasable, because unlike a pencil and paper, the user erases the screen without applying an eraser directly to the marking. Erasable media such as these are preferred as a user such as a child can practice writing numbers on them and can easily erase any markings that the child has made. Trash such as used paper is not generated when such erasable media are used.

In the illustrated embodiment, the writing medium 38 includes a screen with magnetic particles under it. A stylus 26 coupled to a housing 29 can include a magnetic tip at its end. When the user writes on the writing medium 38, magnetic particles are pulled upward towards the magnetic tip to form an image (e.g., the number “6”). The magnetic particles can be suspended in a viscous liquid medium so the magnetic particles maintain their position. In this example, the stylus 26 is coupled to the housing 29 with a cord. However, the stylus can be separated from the housing 29 in other embodiments. To erase the writing medium 38, the user actuates an erase button 36. Here, the erase button 36 has an “L” shape and is pulled down to erase the image formed in the writing medium 38. Another magnet under the magnetic particles pulls the magnetic particles away from the screen to erase the image. Media of this type are commercially available. One type is sold under the name Magna Doodle™. Another type that uses magnetic particles, but uses a somewhat different erasing mechanism is in a product called Flash Magic™, available from LeapFrog Enterprises of Emeryville, Calif.

Writing instruction can be provided by the apparatus 10, or by a parent or a teacher. For example, the apparatus 10 can teach a user how to write numbers. A synthesized voice from a speech synthesizer in the apparatus 10 can instruct the user to practice writing the number 5 on the writing medium 38. Prior to doing so, a processor in the apparatus can cause the display screen 32 to display how to write the number 5 by automatically tracing the form of the number according to the marking strokes that one would normally use to write the number 5. If the writing medium includes an LCD (liquid crystal display), selective pixels in the LCD may sequentially activate to show how the number is written. Musical tones may sound as the numbers are formed in the writing medium 32 to focus the user on the forming number. After the user sees how to write the number, the user can practice writing the number on the writing medium 38 by imitating the writing strokes shown in the display screen 32. Non-erasable lines (not shown) can be provided on the display screen 32 to help guide the user's writing so that the user writes numbers of consistent size. In other embodiments, a parent or teacher can also write on the writing medium 38 to show the user how certain numbers can be written.

Including the writing medium 38, and especially an indirectly erasable writing medium, in the apparatus 10 provides a number of advantages. For example, by providing a writing medium 38, the user can practice writing numbers. Unlike conventional number and math-related, educational apparatuses, a user can not only push buttons to receive responses, but can also practice writing numbers. Any concepts that are learned through electronic interaction with the apparatus can be reinforced by writing. Moreover, erasable writing media are inherently fun for children and can attract them to the interactive apparatus 10. For example, with respect to FIG. 1, a child can indirectly erase the writing medium 38 by actuating the button 36 to its side. Markings appear to “magically” erase since the erasing mechanism is hidden from the user, and its method of operation is not intuitive to the user. In addition, the writing medium 38 is always at a convenient location for the user. The user need not take the time to locate a suitable writing medium to practice writing numbers.

A set of movable objects 16 is also disposed in a recess in the housing 29. The set of movable objects 16 includes an abacus with 20 movable disks. The movable objects can alternatively be shaped as parallelepipeds (cubes), spheres, triangles, or combinations of these shapes. As shown, the set of movable objects 16 may be restrained by a bar 34 that extends within the recess. In other embodiments, a bar need not restrain the set of movable objects. For example, the housing 29 could have a number of individual depressions for individual balls, or a slot for a number of balls (or other objects) that may be separated from each other and also the housing. Balls can be placed within the depressions or the slot and can be grouped together to form groups of balls. The groups of balls are used to illustrate how numbers and math relate to physical objects.

In FIG. 1, movable objects in the set 16 can be grouped together and separated from other movable objects in the set 16 to form groups of objects that correspond to at least some of the numbers in the array 14. Illustratively, to illustrate how 1+2=3, a parent can separate one disk from the other nineteen disks to show a child that one disk represents the number one. Then, the parent can separate two other disks from the one disk and the remaining seventeen disks to show the child that two disks represent the number two. After this, the three disks can be grouped together to show that, a group containing three disks is formed after one disk is added to two disks. In addition to using the set of movable objects 16 to learn how the numbers 1, 2, and 3 interrelate, a user can also learn about the numbers by pressing the buttons associated with the array of numbers 14.

The set of movable objects 16 can be a “smart” set of movable objects in some embodiments, or need not be in other embodiments. For example, a processor (not shown) housed in the housing 29 can automatically determine, with appropriate sensors, how many objects have been grouped together by a user. Automatic feedback (e.g., automatic audio feedback) could be provided to the user in response to a correct or incorrect grouping of objects. In other embodiments, the set of movable objects 16 need not be “smart” and can be purely physical objects without any corresponding electronic function.

By using a set of movable objects 16 along with, for example, the writing medium 38 and the array of numbers 14, concepts such as number recognition, addition, subtraction, number ranges, and numerical values can be further reinforced in the user in many different ways, instead of just by pushing buttons. Unlike conventional apparatuses, a user may learn about numbers and math by writing, manipulating physical objects, answering questions that are posed by the apparatus, and receiving information about selected numbers. Conventional apparatuses do not have the degree of functionality provided by embodiments of the invention.

Suitable audio devices and display devices may also be included in the interactive educational apparatus 10. For example, the embodiment shown in FIG. 1 includes an LCD screen 32 and a speaker 20. The LCD screen can have any suitable characteristics. In an exemplary embodiment, the LCD screen may be a 1.25″×1.25″ STN LCD screen that is capable of displaying numbers, objects, equations, animations, etc. The LCD screen may contain, for example, 32×32 pixels. Selective pixels may illuminate to form an image.

The apparatus 10 also includes a Help button 30, a volume button 22, a skill level button 24 (e.g., easy or hard) and a mode selection device 12. The user can press the Help button 30 if the user needs assistance with a particular question that is posed by the apparatus 10. When pressing the Help button 30, visual and/or audio clues may be presented to the user to help the user answer the question.

The apparatus 10 includes a number of different operational modes. In this example, the user can change the position of the mode selection device 12 to turn the apparatus 10 off 15(a), or into a learn mode 15(b), a count mode 15(c), a mystery number mode 15(d), an addition mode 15(e), a subtraction mode 15(f), or a beat-the-clock mode 15(g). A music mode (not shown) could also be provided in the apparatus 10. In some embodiments, the illustrated apparatus 10 can include all of these modes. In other embodiments, fewer or more functional modes may be included in the apparatus. Each of these specifically mentioned modes is described in greater detail below.

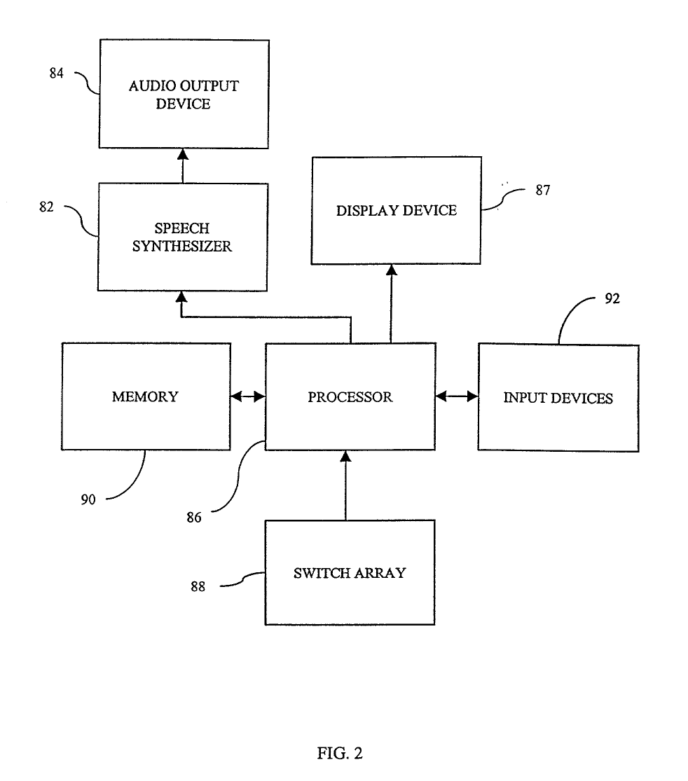

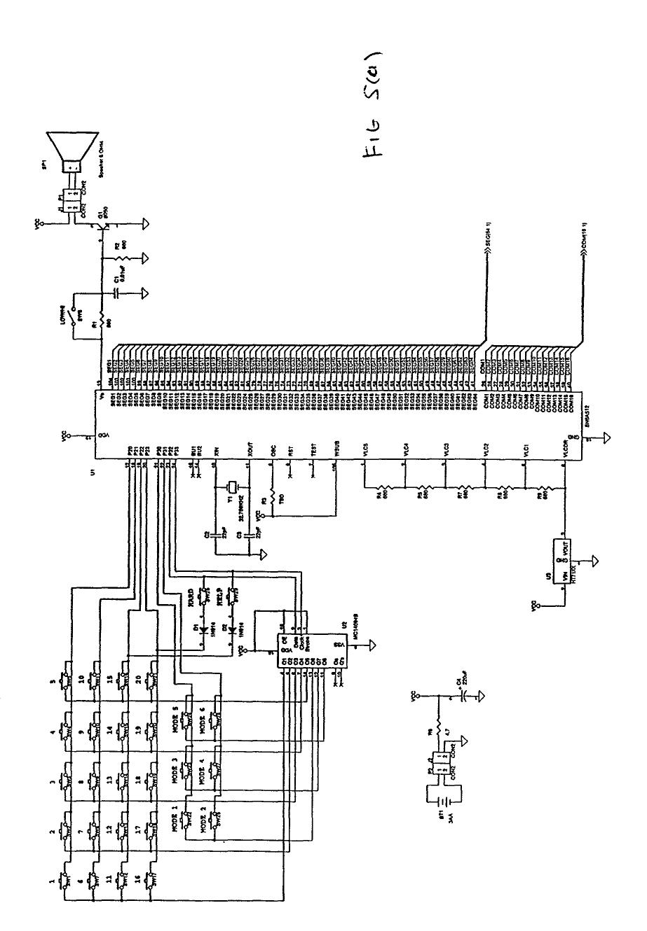

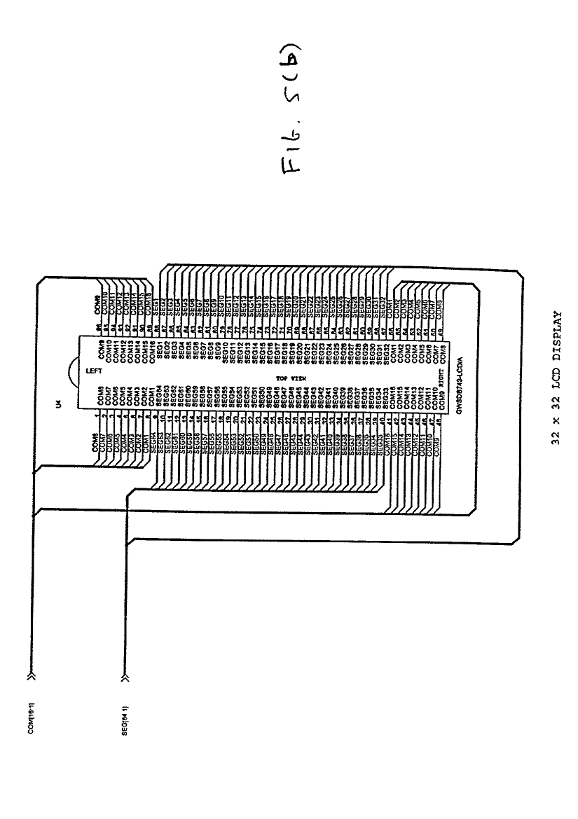

FIG. 2 shows a block diagram of some components of the apparatus according to an embodiment of the invention. The apparatus may comprise a processor 86 such as a microprocessor. A switch array 88, memory 90, an input device 92, a speech synthesizer 82, an audio output device 84, and a display device 87 may be coupled (directly or indirectly) to the processor 86. A specific example of a circuit diagram for an apparatus embodiment is shown in FIGS. 5(a) and 5(b). Although a specific circuit implementation is illustrated, it is understood that any suitable circuit can be used to accomplish the functions of the apparatus.

Power can be supplied to the apparatus using standard disposable or rechargeable batteries (e.g., size AA batteries). In addition, the apparatus may include an automatic shut off feature that shuts off the apparatus if the user does not interact with it in a predetermined period of time. The apparatus could be turned back on by manipulating any button or lever in the apparatus.

Any suitable input device 92 may be included in the study aid apparatus. For instance, one or more buttons, levers, knobs, etc. can be included in the apparatus. As noted above, Help buttons, mode selection devices, volume controls, and skill selecting devices are some examples of input devices.

The memory 90 may be any suitable temporary or permanent information storage device. For example, the memory 90 may include one or more of optical, magnetic, or electronic storage media such as optical or magnetic disks, tapes, sticks, and the like. Storage devices such as these may be used alone or in combination to make up the memory 90. Any suitable number of RAM (random access memory), ROM (read only memory) and EPROM (erasable programmable memory) chips may also be included in the memory 90. Computer code for carrying out the functions of the apparatus may be stored in the memory 90. Code for re-useable graphic image segments or audio segments can be stored in the memory 90. Corresponding code for instructions to play the reusable graphic image and audio segments may also be stored in the memory 90.

The speech synthesizer 82 may be a separate speech synthesizer chip or speech synthesizer circuitry that can be on the same or different chip than the processor. For example, a speech synthesizer such one that is in a SONIX SN6A512 chip, commercially available from Sonix Technology Co., Ltd. can be used in the apparatus 10.

The switch array 88 may include an array of pressure sensitive switches. The number of switches in the switch array 88 may correspond to the highest number in the number array. For example, in the embodiment shown in FIG. 1, the highest number in the number array is 20 and there can be 20 corresponding switches respectively disposed under the number array.

The audio output device 84 may include a speaker, or an audio jack or connection for a headphone or an earphone. An audio amplifier (not shown) may amplify any signals to the audio output device 84.

The display device 87 can include a display screen and associated electronics to cause an image to be displayed on the display screen. Suitable display devices include LED (light emitting diodes) displays and LCDs (liquid crystal displays).

In some embodiments, a transferable information storage medium (not shown) may be used with the apparatus. For instance, a data cartridge, a disk, a tape, or a memory stick may be used to transfer computer code to and from the apparatus. Cartridges are especially desirable since they can be easily manipulated and handled by children. Any suitable amount of storage space may be provided on the transferable information storage medium. Preferably, the capacity of the information storage medium is at least about 512 K (e.g., 4 megabytes or more).

In some embodiments, the code that is transferred by the transferable information storage medium may originate from a server computer that is accessible via the Internet. Alternatively, the code could come from information storage media with new content that may be separately purchased, for example, at a local store. In some embodiments, new computer code can be provided to the apparatus from a computer apparatus through a wired communication link or a wireless communication link (e.g. an RF (radio frequency) or IR (infrared) transceiver). Regardless of how it is obtained, the new computer code can update the apparatus with new problems, questions, operational modes, music, sounds, instructions to play pre-stored audio segments or image segments, etc., if desired.

As noted above, the apparatus may have many different operational modes. For example, in some embodiments, the apparatus can have a learn mode, a count mode, a mystery number mode, an addition mode, a subtraction mode, a beat-the-clock mode, and/or a music mode. Each of these modes may contain two or more levels of difficulty. For instance, in a typical embodiment, each mode could contain an easy level and a hard level. These levels may be user selectable or could be automatically selected by the apparatus depending upon the level of skill of the user.

In the learn mode, the apparatus can help a user identify and recognize numbers. In a typical example, a voice from the apparatus prompts the user to press a number. The user presses a number and the voice declares the name of the number depressed. A processor can then cause the display screen to display a particular sequence of markings that form the number to show how the number is written. The user can then try and imitate the markings by writing in the writing medium of the apparatus.

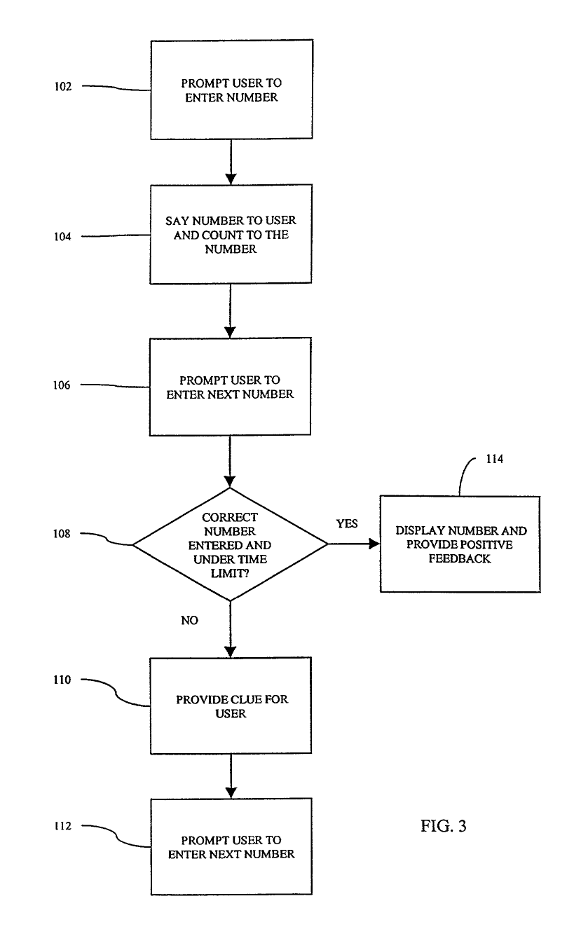

In the counting mode, the user can learn how to count to a variety of numbers. An exemplary method for teaching counting can be described with reference to FIG. 3. First, the apparatus prompts the user to enter a number (step 102). For example, the apparatus may say “Press a number from 1 to 10 to hear its name”. After the user presses a number, the voice says the number to the user and counts to the number pressed (step 104). For instance, if the user selects “4”, a voice from the apparatus counts “1, 2, 3, 4” while the display screen shows the numbers 1, 2, 3, and 4. The number images and the audio for the numbers may be synchronized. After counting, the voice can then prompt the user to enter the next number (step 106). For example, after counting to “4”, the apparatus can ask the user “What comes next?” The display screen may display a question mark (i.e., “?”). If the user enters the correct number within a predetermined time limit (e.g., 1 minute) for answering the question, then positive feedback can be provided to the user (steps 108, 114). For example, if the next number is “5” and the user presses the “5” button, then the voice may say a positive phrase such as “That's right!” The voice can then count “1, 2, 3, 4, 5”, and the display screen can display the numbers, 1, 2, 3, 4, and 5 to the user. If the child selects the wrong number, then the apparatus can provide a clue for the user (steps 108, 110). For example, a voice from the apparatus can prompt the user to press the “Help” button to receive a clue. After pressing the “Help” button, the voice can count “1, 2, 3, 4”. Four balls (or other images) can sequentially appear on the display screen to represent the numbers 1, 2, 3, and 4. After a brief pause, a fifth ball can be displayed on the display screen along with the other four balls. After providing this clue, the voice prompts the user to enter the next number (step 112). If the user still cannot answer the question correctly, the voice may give the correct answer to the user by saying the correct number along with the numbers leading to the correct number (e.g., “5, 1, 2, 3, 4, 5”). Visual images of the numbers may be displayed to the user while the voice recites the numbers. After the correct number is recited by the voice, the voice can prompt the user to enter the correct number. The apparatus can then repeat this process if the user wants to continue in this mode.

In the mystery number mode, the user can try and determine which number or numbers that the apparatus is thinking of. In this mode, the user can learn the relationships between numbers and the relative values of numbers. Numerical ranges are also taught. At an easy level, a voice from the apparatus can ask the user to enter a number above or below a particular number. The particular number may be automatically selected by the apparatus or may have been previously entered by the user. At a hard level, a voice can ask the user to enter a number that is between two particular numbers. The two numbers may be chosen by the apparatus or may have been previously selected by the user.

Illustratively, a voice from the apparatus can say “I'm thinking of any number bigger than 3” or “I'm thinking of a number smaller than 12”. Then, the voice from the apparatus can say, “can you guess what number it is?” If the user presses the correct number, the display screen displays the correct number and the voice congratulates the user. Then, markings can be automatically produced on the display screen to show the user how to write the number. The voice may then optionally prompt the user to practice writing the number.

If the user provides the wrong answer, the question is repeated, and the voice can prompt the user to press the Help button to receive a clue. In an exemplary clue, the display screen in the apparatus can display a number of objects (e.g., balls, blocks, stars, etc.). The objects in the display screen represent a number that is the correct answer to the question. The voice can then ask the user to count the balls on the screen to find the correct number. If the user enters the correct number, the number is shown on the screen and the user is congratulated. If the user still gives the wrong answer, the voice says the right answer for the user and then prompts the user to press the button associated with the correct number.

In an addition mode, the user can learn basic or complex addition operations. At an easy level, a starting number (e.g., a number from 1 to 17) is provided and a low number (e.g., from 1 to 3) is added to it. The starting number may be provided automatically by the apparatus or may be selected by the user. At a hard level, the starting number can be, for example, from 1 to 11, while the add-on number can be, for example, from 1 to 9.

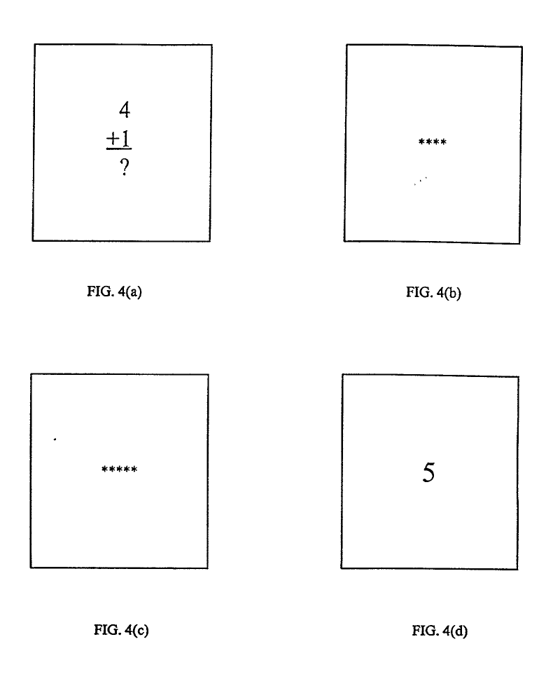

In a typical example, a voice from the apparatus can prompt a child to press a number and the user is asked to add another number to it. For instance, after the user presses the number 4, the apparatus can say, “I've got 4. If you gave me 1, how many would I have?” At substantially the same time, as shown in FIG. 4(a), a display screen can display the particular addition operation in a vertical format. If the child presses the correct number (e.g., 1), then the voice will say the correct number and the display screen can display the correct number. The voice may also congratulate the user. After this, the entire addition operation can be repeated. For example, the voice can say “4 plus 1 makes 5”. Then, the display screen can show how to write the number 5 and invite the user to do the same.

If the user gets the answer to the addition question wrong, the voice from the apparatus can encourage the user to try again, repeat the question, and prompt the user to receive a clue. For example, the voice can say, “let's try again. I've got 4, if you gave me 1, how many would I have? Press the Help button to receive a clue”. After pressing the Help button, the voice can say, “I've got 4 balls”. Substantially simultaneously with this audio script, as shown in FIG. 4(b), the display screen in the apparatus can show 4 balls bouncing onto the screen. Then, the voice can count to four (i.e., “1, 2, 3, 4”), and can also say, “If you gave me 1 ball, how many would I have?” A single ball can then bounce onto the display screen, as shown in FIG. 4(c). When the balls appear to fall onto the display screen, beep tones for each of the balls can be provided to draw the user's attention to the balls. As shown in FIG. 4(c), the total number of balls equals the correct answer. If the user needs further clues, the Help button can be pressed and a voice can say “we start with 4 and add on 1; 1, 2, 3, 4, 5 makes 5. That's the total number!” The voice then prompts the user to press the number 5.

In a subtraction mode, subtraction operations are taught. At an easy level, the apparatus starts with a number (provided by the user or apparatus) such as a number from 1 to 20, and then subtracts a low number such as a number from 1 to 3. At a hard level, the apparatus starts with a number such as a number from 2 to 20 and subtracts a number such as a number from 1 to 9.

Illustratively, the voice prompts a child to press a number and then informs the user that the current mode is a subtraction mode. The voice for the apparatus may then say, “I've got 5. If I gave away 2, how many would I have?” The display screen can show the subtraction operation in a vertical format (similar to the addition operation in FIG. 4(a)). If the correct number is pressed, the user can see or hear a positive phrase and the correct number. For example, the voice can say, “5, take away 2 makes 3. Then, the apparatus shows how to write the number.

If the user gives the wrong answer, the apparatus can encourage the user to try again, by providing an inviting statement, repeating the question, and prompting the user to receive a clue. For example, the voice may say, “Let's try again. I've got 5, if I gave away 2, how many would I have? Press Help to receive a clue or press the answer.”

Multiple clue levels may be provided in this mode or in any other mode. As the user uses additional clues, each additional clue leads to the correct answer. In embodiments of the invention, the apparatus does not simply “give away” the correct answer if the user gives the wrong answer. Rather, the apparatus leads the user to the answer while making the user think about how to arrive at the correct answer. For example, the voice from the apparatus can say, “I've got 5 balls. 1, 2, 3, 4, 5. If I gave away 2 balls, how many would I have? Count the balls on the screen to find out the answer”. Then, the display screen would show two balls bouncing off of the screen. Beep tones may be provided when balls are taken on or off the screen. If the user still cannot determine the right answer, the voice can say, “let's count the balls together. We start with 5 and take away 2. What's left? 1, 2, 3. That's the answer!” Then, the apparatus prompts the child to press the number 3 to reinforce this learning session.

In the “beat the clock” mode, the apparatus can test the user's ability to answer questions within a predetermined period of time. It can be considered a game mode where the user can have fun by playing a game and obtaining a score, while also learning. In embodiments of the invention, after playing a “beat the clock” game, the user's score can be recorded in the apparatus and can be presented to the user. Subsequent scores can also be recorded so that “personal best” scores can be presented to the user. In this mode, background music could play as the user tries to answer as many questions as possible within a predetermined period of time. The problems may relate, for example, to number recognition, numerical relationships, addition, subtraction, division, multiplication, etc.

Illustratively, a voice from the apparatus can say, “let's play beat the clock. You've got 90 seconds.” The voice can then tell the user the high score to date. Then, the game can start. The voice provides a question for the user. The user gets one chance to answer the question. If the user answers the question correctly, the user gets a point and the voice presents another question to the user. If the user answers the question incorrectly, another question is presented to the user and the question that was answered incorrectly is not presented to the user again. Additional questions are presented to the user and the user tries to answer as many questions as possible within the predetermined time limit.

In some specific examples, at an easy level, a voice from the apparatus can ask 3 types of questions in this mode. The types of questions may pertain to number recognition (e.g., “Touch the number 5”) and counting (e.g., “What number comes after 5” or “What number comes before 5”). At a hard level, the voice from apparatus can present the user with addition or subtraction questions. When the time is up and the game is over, the voice can tell the user how many problems were correctly answered. The voice may then prompt the user to press a number to play another game.

The apparatus may also have a music mode. In the music mode, the child can press a number. After pressing a number, a rhythmic song is played that counts up to that number. The background music of the song gets interspersed with the spoken numbers. In some embodiments, a different song can be played for each button that the user presses.

In some embodiments, it is possible for the interactive educational apparatus to “adapt” to the skill level of the user so that interesting and challenging questions are presented to the user. The apparatus may contain appropriate software to adapt to the user's level of skill so that questions suitable for the user are presented to the user. Alternatively or additionally, the software for adapting to the user's skill level could reside on an external computer (e.g., a server computer) and appropriate problems for the user's level of skill could be downloaded into the apparatus. Adaptive learning methods, systems, and devices, are described in greater in U.S. patent application Ser. No. 09/632,424, filed Aug. 4, 2000. This U.S. patent application is assigned to the same assignee as the present application and is herein incorporated by reference in its entirety for all purposes.

Various scripts that can be used in embodiments of the invention are described in U.S. Provisional Patent Application No. 60/301,144, which is herein incorporated by reference in its entirety.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed. Moreover, any one or more features of any embodiment of the invention may be combined with any one or more other features of any other embodiment of the invention, without departing from the scope of the invention.

What is claimed is:

1. An interactive educational apparatus comprising:
a) an array of switches;
b) an array of numbers respectively associated with the array of switches;
c) a processor operatively coupled to the array of switches;
d) an output device operatively coupled to the processor;
e) a memory operatively coupled to the processor;
f) a housing, wherein the processor is housed in the housing; and
g) a set of movable physical objects coupled to the housing, wherein the physical objects within the set are capable of being grouped together to form a group of objects that represents at least some of the numbers in array of numbers.

2. The apparatus of claim 1 wherein the array of numbers is buttons that are respectively disposed over the array of switches.

3. The apparatus of any of claim 1 wherein the output device is an audio output device.

4. The apparatus of any of claim 1 wherein the output device is a first output device, the first output device being a speaker, and wherein the apparatus further includes a second output device, the second output device being a display screen.

5. The apparatus of any of claim 1 wherein the output device is a first output device, the first output device being a speaker, and wherein the apparatus further includes a second output device, the second output device being a liquid crystal display screen.

6. The apparatus of any of claim 1 wherein the memory comprises pre-stored computer code for graphic images and audio segments.

7. The apparatus of any of claim 1 wherein the apparatus includes a plurality operational modes, the operational modes including (i) an addition mode, and (ii) a subtraction mode.

8. The apparatus of claim 1 wherein the apparatus includes (i) an addition mode, (ii) a subtraction mode, (iii) a counting mode, and (iv) a mystery number mode.

9. The apparatus of claim 1 further comprising:
an erasable writing medium.

10. The apparatus of claim 1 further comprising an erasable writing medium where the user can practice writing numbers.

11. The apparatus of claim 1 further comprising:
a stylus attached to the housing.

12. The apparatus of claim 1 further comprising:
an erasable writing medium comprising magnetic particles.

13. An interactive educational apparatus comprising:
a) an array of switches;
b) an array of numbers respectively associated with the array of switches;
c) a processor operatively coupled to the array of switches;
d) an output device operatively coupled to the processor;
e) a memory operatively coupled to the processor;
f) a housing, wherein the processor is housed in the housing; and
g) a writing medium spaced from the array of numbers.

14. The apparatus of claim 13 wherein the writing medium is an erasable writing medium.

15. The apparatus of claim 13 wherein the writing medium is an erasable writing medium comprising magnetic particles.

16. The apparatus of claim 13 wherein the writing medium is capable of being indirectly erasable.

17. The apparatus of claim 13 wherein the writing medium is capable of being indirectly erasable when the user actuates an actuating member to a side of the erasable writing medium.

18. The apparatus of claim 13 further comprising:
a stylus coupled to the housing.

19. The apparatus of claim 13 wherein the apparatus further comprises a plurality of different operational modes including (i) an addition mode, and (ii) a subtraction mode.

20. The apparatus of claim 13 further comprising:
a set of movable physical objects coupled to the housing, wherein the physical objects within the set are capable of being grouped together to form a group of objects that represents at least some of the numbers in array of numbers.

21. The apparatus of claim 13 wherein the apparatus comprises a handle.

22. The apparatus of claim 13 wherein the apparatus is an educational toy.

23. The apparatus of claim 13 wherein the apparatus is an educational toy adapted to teach a pre-school age child, a toddler, or an elementary school age child.
